(19) United States
(12) Patent Application Publication
(10) Pub. No.: US 2026/0134728 A1
(43) Pub. Date: May 14, 2026

(54) SYSTEM AND METHOD FOR VEHICLE FAILURE DETECTION

(71) Applicant: Torc Robotics, Inc., Blacksburg, VA (US)

(72) Inventors: Nicholas Atanasov, Austin, TX (US); Pablo Smith, Spicewood, TX (US); William Gray Davis, Austin, TX (US); Akshay Pai Raikar, Austin, TX (US); Christopher Harrison, Austin, TX (US)

(21) Appl. No.: 18/945,443

(22) Filed: Nov. 12, 2024

(51) Int. Cl. G07C 5/08; G07C 5/00

(52) U.S. Cl. CPC G07C 5/0866; G07C 5/008; G07C 5/0816

(57) ABSTRACT

A system for vehicle failure detection is provided. The system includes sensors associated with a primary vehicle to detect a secondary vehicle around the primary vehicle, and a database configured to electronically store characteristic failure thresholds. The system includes a processing device that detects a characteristic associated with the secondary vehicle with the one or more sensors, determines if the detected characteristic associated with the secondary vehicle meets or exceeds the characteristic failure threshold corresponding with the characteristic, and if the detected characteristic exceeds the characteristic failure threshold corresponding with the characteristic, identifies the secondary vehicle as having a detected failure.

### TECHNICAL FIELD

The field of the disclosure relates to vehicle failure detection and, in particular, to a system for detecting and informing surrounding vehicles of possible failure conditions as a primary vehicle travels along a route.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

As the autonomous vehicle travels along its route, it passes various other secondary vehicles, such as trailer trucks. Conventionally, manual checks are performed for the secondary vehicles before or after operation by the driver. In some instances, the driver observes how the secondary vehicle handles during the travel along the route and, based on the driver's subjective opinion, a determination is made whether maintenance or further review may be needed of the vehicle. However, it may be difficult to determine if, e.g., brake overheating, smoke, or other failure conditions are occurring while the driver is behind the wheel.

Accordingly, there exists a need for a system and a method of vehicle failure detection that allows for detecting and (optionally) notifying secondary vehicles of potential component failure. These and other needs are met by the exemplary system for vehicle failure detection discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for vehicle failure detection is provided. The system includes one or more sensors associated with a primary vehicle. The one or more sensors configured to detect a secondary vehicle around the primary vehicle. The system includes a database configured to electronically store characteristic failure thresholds. The system includes a processing device in communication with the one or more sensors and the database. The processing device is configured to execute instructions stored in a memory to perform operations that include detecting a characteristic associated with the secondary vehicle with the one or more sensors. The operations include determining if the detected characteristic associated with the secondary vehicle meets or exceeds the characteristic failure threshold corresponding with the characteristic. If the detected characteristic exceeds the characteristic failure threshold corresponding with the characteristic, the operations identifying the secondary vehicle as having a detected failure. Although discussed herein as identifying a detected failure of a secondary vehicle, in some embodiments, the system can be used to detect characteristics associated with the primary vehicle itself to determine if there is a failure of the primary vehicle.

In some embodiments, the primary vehicle can be an autonomous vehicle. The one or more sensors can include, e.g., a heat detection sensor, a sound detection sensor, a visual sensor, combinations thereof, or the like. In some embodiments, the heat detection sensor can be an infrared sensor. In some embodiments, the sound detection sensor can be a microphone. In some embodiments, the visual sensor can be a camera.

In some embodiments, the detected characteristic associated with the secondary vehicle can be an overheating of one or more components of the secondary vehicle, and the heat detection sensor detects such overheating. In some embodiments, the one or more components can include at least one of brakes, an engine, bearings, or an axle. In some embodiments, the detected characteristic associated with the secondary vehicle can be an increased sound of one or more components of the secondary vehicle, and the sound detection sensor detects such increased sound. In some embodiments, the detected characteristic associated with the secondary vehicle can be an increased frequency of sound of one or more components of the secondary vehicle, and the sound detection sensor detects such increased frequency of sound. In some embodiments, the detected characteristic associated with the secondary vehicle can be an existence of smoke or fire from the secondary vehicle, and the visual sensor detects such existence of smoke or fire.

In some embodiments, the detected characteristic associated with the secondary vehicle can be a deflated tire of the secondary vehicle, and the visual sensor detects such deflated tire. In some embodiments, the sound detection sensor can be configured to detect a deviation of sound of the secondary vehicle relative to a noise baseline expected for the secondary vehicle. In some embodiments, the operations can include transmitting an alert to the secondary vehicle of the detected failure from the primary vehicle. In some embodiments, the operations can include transmitting an alert to a mission control of the detected failure from the primary vehicle.

In another aspect, an exemplary computer-implemented method for vehicle failure detection is provided. The method includes electronically storing characteristic failure thresholds in a database, and detecting a secondary vehicle around a primary vehicle with one or more sensors associated with the vehicle. The method includes executing instructions stored in a memory with a processing device in communication with the one or more sensors and the database to perform operations that include detecting a characteristic associated with the secondary vehicle with the one or more sensors. The operations include determining if the detected characteristic associated with the secondary vehicle meets or exceeds the characteristic failure threshold corresponding with the characteristic. If the detected characteristic exceeds the characteristic failure threshold corresponding with the characteristic, the operations include identifying the secondary vehicle as having a detected failure.

In some embodiments, the one or more sensors can include, e.g., a heat detection sensor, a sound detection sensor, a visual sensor, combinations thereof, or the like. In some embodiments, the detected characteristic associated with the secondary vehicle can be an overheating of one or more components of the secondary vehicle, and the heat detection sensor detects such overheating. In some embodiments, the detected characteristic associated with the secondary vehicle can be an increased sound of one or more components of the secondary vehicle, and the sound detection sensor detects such increased sound. In some embodiments, the detected characteristic associated with the secondary vehicle can be an increased frequency of sound of one or more components of the secondary vehicle, and the sound detection sensor detects such increased frequency of sound.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck.

FIG. 2 is a block diagram of the autonomous truck shown in FIG. 1.

FIG. 3 is a block diagram of an example computing system.

FIG. 4 is a block diagram of an exemplary system for vehicle failure detection.

FIG. 5 is a flowchart of a method for vehicle failure detection.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for vehicle failure detection advantageously allows for an autonomous vehicle traveling along a route to monitor and detect characteristics of vehicles around it to determine if any surrounding vehicles have one or more components that may be failing. As used herein, the term “fail”, “failing” or “failure” refers operation of a component of a vehicle outside of its normal operation as intended by the manufacturer. Such failure can include, but is not limited to, e.g., overheating of brakes, overheating of an engine, overheating of bearings, overheating of an axle, increased/decreased sound of operation of a component, increased/decreased pitch of operation, rattling sound, increased/decreased frequency of sound, existence of smoke or fire, deflated tire, deviation from noise baseline expected for vehicle, combinations thereof, beyond normal or typical vibrations, or the like. For example, in some embodiments, the system can be programmed with the noise baseline expected for each type of vehicle, and the sensors allow the system to detect any deviation from such baseline. Once failure of a component of the vehicle has been detected, the autonomous vehicle can alert either the vehicle and/or mission control to prevent further damage to the vehicle.

As additional examples, in some embodiments, the system can detect excessive vibrations in the vehicle's chassis or steering components, identify fluid leaks such as oil or coolant, monitor for electrical malfunctions including flickering lights, recognize abnormal tire pressure, or combinations thereof. Further, the system can detect unusual sounds from the suspension system, irregularities in the brake response, and/or issues with the exhaust system. In some embodiments, the system can identify transmission slippage, heating system malfunctions, cooling system failures, power steering issues, and/or sensor failures. In some instances, these detections can occur through the extremely accurate laser based measurements (LiDAR), which provides information related to vehicle sub-component states, e.g., an abnormally shaped tire detected through LiDAR measurements can indicate a flat tire. LiDAR sensors can be used to detect differences in surface reflectance, hence discerning between asphalt and oil spilling from a vehicle, for example. Infrared based sensors can support detection of heat spots on neighboring vehicles and thus identify potential fires preemptively.

The system relies on sensors on the autonomous vehicle to detect the surrounding vehicle(s) and its characteristics or operating conditions. In some embodiments, substantially similar sensors can be used to monitor components of the autonomous vehicle itself, thereby alerting the vehicle and/or mission control if failure is detected at one or more components. The sensors allow the autonomous vehicle to detect situations, such as high heat areas, on other vehicles to infer a likelihood of failure (e.g., break overheat, axle failure, bearing failure, tire deflation, smoke, or the like). Microphones or other sound recording devices can be used to detect sounds of failing components/parts on other vehicles. The information can be displayed on the autonomous vehicle and can be transmitted to the affected vehicle through a variety of means, e.g., short message service (SMS), citizens band (CB) radio, human machine interface (HMI), or the like. The system therefore assists with detecting potential mechanical and/or electrical failures on surrounding vehicles, and warns drivers of these vehicles regarding the potential failure to ensure these issues can be timely addressed.

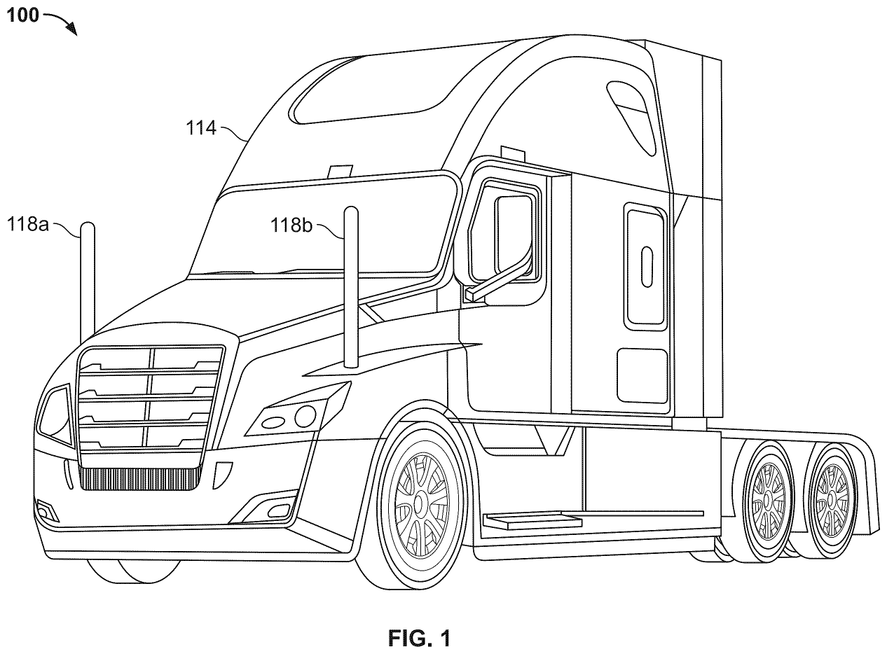

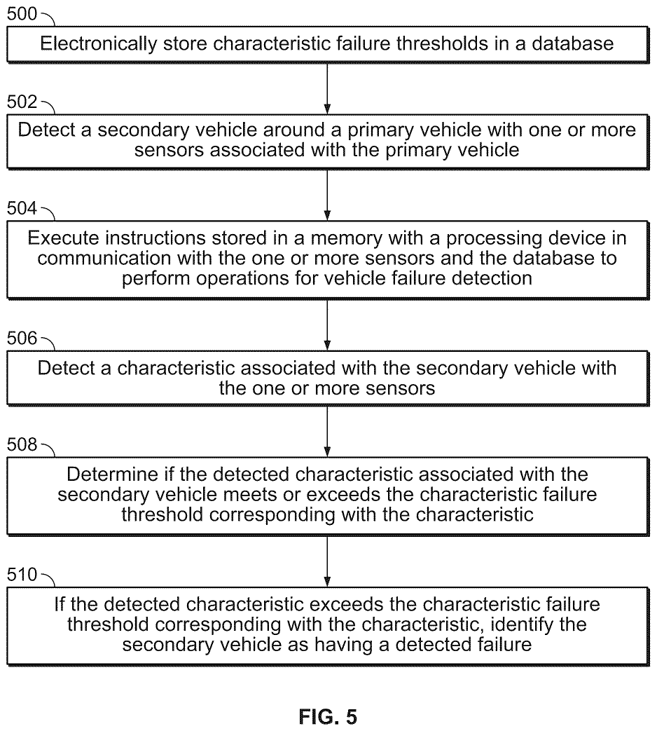

Various embodiments in the present disclosure are described with reference to FIGS. 1-5 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors. For example, the vehicle 100 can include one or more antenna 118a, 118b at or near the front of the vehicle 100 with sensors having a field-of-view at the front and/or sides of the vehicle 100.

Similar sensors can be used around the perimeter of the vehicle 100 to ensure full environmental coverage around the vehicle 100 is provided by the sensors. In some embodiments, the vehicle 100 can include, e.g., 5-6 LIDAR sensors, 8-10 cameras, combinations thereof, or the like. In some embodiments, the vehicle 100 can tow a trailer and the trailer can similarly include LIDAR sensors and/or cameras to provide field-of-view coverage around the perimeter of the vehicle 100 and the trailer. The environmental coverage by the sensors and/or cameras therefore provides data corresponding with the front, rear, sides and corners of the vehicle 100 and the trailer hauled by the vehicle 100.

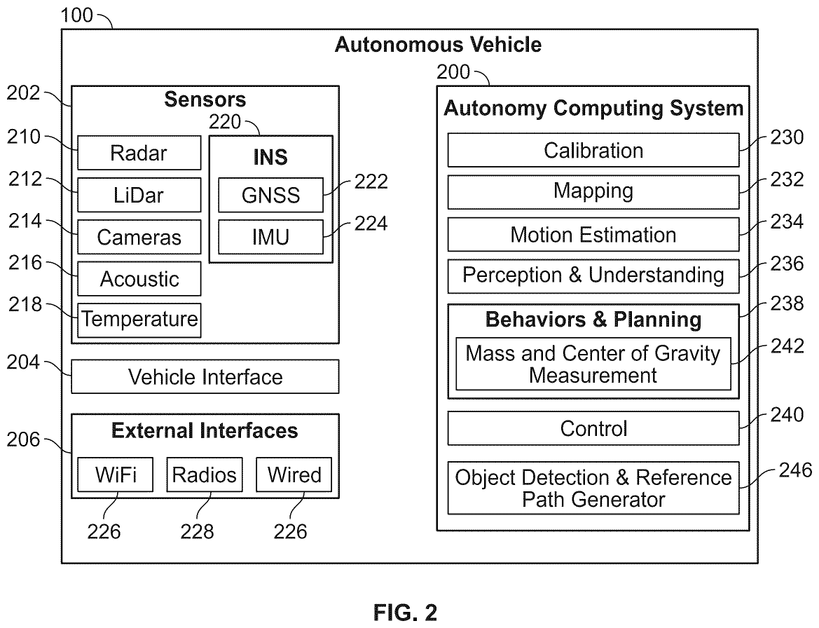

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

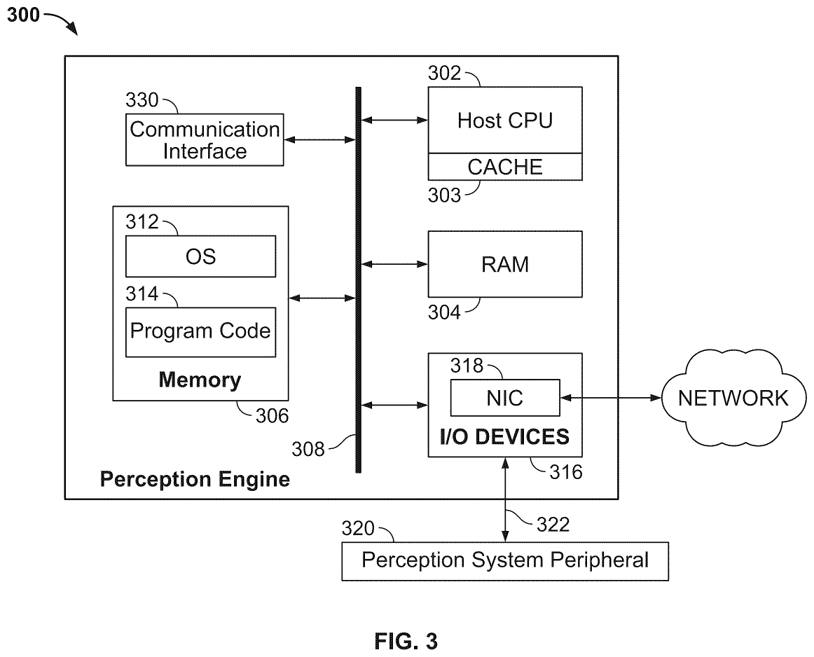

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

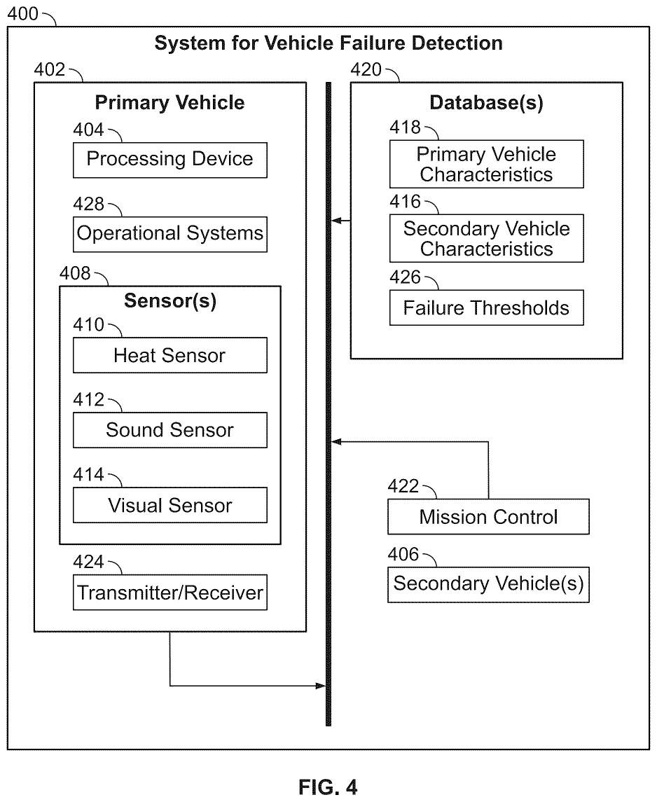

FIG. 4 is a block diagram of an exemplary system 400 for vehicle failure detection. The system 400 generally includes one or more vehicles 402 (e.g., autonomous vehicle 100), i.e., primary vehicle. Each vehicle 402 includes various operational system 428, e.g., computing system 200, for controlling operation of the vehicle 402 and detecting objects, obstacles and other vehicles 406 around the vehicle 402. Each vehicle 402 includes a processing device 404 (e.g., computing system 200, computing system 300, or the like) configured to receive and process data for determining whether surrounding vehicles 406, e.g., secondary vehicles, have one or more component operational failures.

At least some of the data received by the processing device 404 can be data from one or more sensors 408 (e.g., sensors 202). For examples, the sensors 408 can be used to physically detect the secondary vehicles 406 as the vehicle 402 travels along its route. The sensors 408 further detect certain characteristics 416 associated with the detected secondary vehicles 406. These characteristics 416 relate to the operational conditions of the secondary vehicles 406. In some embodiments, the sensors 408 can similarly be used to detect operational characteristics 418 or conditions of the vehicle 402 itself, thereby determining whether the vehicle 402 has one or more components undergoing failure. The sensors 408 are therefore usable to gather metrics on the vehicle 402 and surrounding vehicles 406. The detected characteristics 416, 418 can be electronically stored on one or more databases 420 in communication with the vehicle 402.

The vehicle 402 can include a variety of sensors 408, such as but not limited to, e.g., thermal or heat sensors 410, sound sensors 412, visual sensors 414, combinations there, or the like. In some embodiments, the sensors 408 can include LiDAR or other radar-based sensors. These sensors 408 can be pointed or directed around the perimeter of the vehicle 402 to detect a variety of characteristics associated with vehicles 406 around the vehicle 402. In some embodiments, the heat sensor 410 can be an infrared sensor, although alternative heat sensors 410 could be used. In some embodiments, the sound sensor 412 can be a microphone, although alternative sound sensors 412 could be used. In some embodiments, such sound sensors 412 can be used to detect vibrations or rattling noises. In some embodiments, the visual sensor 414 can be a camera, although alternative visual sensors 414 could be used.

The vehicle 402 can include one or more databases 420 (e.g., memory 306) configured to receive and electronically store data. In some embodiments, the database 420 can be stored externally from the vehicle 402 and the vehicle 402 can be in communication with the external database 420 for receiving and/or transmitting data associated with the system 400. For example, the database 420 can be in communication with both the vehicle 402 and mission control 422, such that data from the database 420 can be communicated to and from the vehicle 402 and mission control 422. In some embodiments, a transmitter/receiver 424 can be used as a communication means between the vehicle 402 and mission control 422 (as well as the secondary vehicles 406).

The database 420 can be programmed to include a variety of operational failure thresholds 426. The failure thresholds 426 can include numerical values or ranges corresponding with baseline “normal” operation for characteristics of the vehicles 406, as well as numerical values or ranges that are indicative of “abnormal” operation for characteristics. For instance, normal engine temperature can range from about 190° F. to about 225° F. (88° C. to 104° C.), inclusive, while temperatures exceeding 230° F. (110° C.) or 240° F. (115° C.) can indicate overheating (with temperatures above 260° F. (127° C.) resulting in critical failure. The bulk drum temperature of the brake drum should not exceed about 600° F., with normal ranges between about 300 and about 500° F., inclusive. Normal vibration levels in the vehicle's chassis can be between about 0.1 to about 0.5 g, inclusive, in amplitude and under about 20 Hz in frequency, with levels exceeding about 0.7 g and/or about 20 Hz suggesting possible issues or natural resonances which could result in equipment failure. Normal tire pressure can be about 85 to about 110 psi, inclusive, and deviations below about 80 psi or above about 120 psi can signal tire pressure problems. Tire thread can potentially be measured with typical values being about 2/32 of an inch along major grooves on the trailer tires and about 4/32 of an inch on the steer, with any deviation from these amounts indicating low tire threads. Baseline noise levels for normal engine operation can be about 81 to about 87 dB, inclusive, for vehicles in motion, with deviations to about 100 dB or higher suggesting potential issues. Normal transmission temperatures can range from about 175° F. to about 220° F. (80° C. to 104° C.), inclusive, with temperatures above about 230° F. (110° C.) indicating overheating. Normal passenger car temperatures can range from about 200° F. to about 400° F. (93° C. to 204° C.), inclusive, with temperatures above this range indicating abnormal operation (and temperatures approaching 700° F. (371° C.) or 800° F. (427° C.) resulting in near failure). In some embodiments, the failure thresholds 426 can be specific to the make and model of the vehicle 406. In some embodiments, the failure thresholds 426 can be generalized based on vehicle type, e.g., passenger car, sedan, van, SUV, truck and trailer, or the like. As an example, one failure threshold 426 can include the normal temperature range for the engine area of the vehicle 406, and any increased temperature value above the normal temperature range would be indicative of overheating of the engine, e.g., engine failure. As another example, one failure threshold 426 can include the normal temperature range for the brakes/brake area of the vehicle 406, and any increased temperature value above the normal temperature range would be indicative of overheating of the brakes. A similar assessment can be made for areas of the vehicle 406 in which bearings and/or axles may overheat.

As another example, one failure threshold 426 can be the baseline range or value of frequency and/or level of noise during operation of the vehicle 406, with any deviation above this baseline value/range considered abnormal operation and indicative of failure. For example, a higher than normal decibel level emitted from a normal functioning engine (and/or high frequency noise from the engine) may be indicative of impending engine failure. As another example, a hum or other sound not typically produced during normal operation having a predetermined frequency and or sound level, can be indicative of a component failure. In some embodiments, the system 400 can search for spikes in certain modes of operation, frequencies, and/or heat. In some embodiments, the system 400 can monitor for an increasing amplitude of sound or a continuously increasing heat reading without a reduction as indicative of an impending failure. As another example, a rattling or vibration noise bay be indicative of axle misalignment.

Non-limiting examples of detected sounds and possible causes detectable by the system are provided herein. For example, a detected squealing sound of brakes in a range of about 1-5 kHz, inclusive, can indicate worn brake pads. As another example, a detected grinding sound of brakes in a range of about 100-500 Hz, inclusive, can indicate metal on metal contact. As another example, a detected knocking sound of the engine in a range of about 5-10 kHz, inclusive, can indicate ignition timing issues. As another example, a detected tapping sound of the engine in a range of about 1-3 kHz, inclusive, can indicate valve lifter issues. As another example, a detected humming sound of wheel bearings in a range of about 100-400 Hz, inclusive, can indicate worn wheel bearings. As another example, a detected whining sound of wheel bearings in a range of about 200-300 Hz, inclusive, can indicate differential issues. As another example, a detected whining sound of the transmission in a range of about 200-400 Hz, inclusive, can indicate transmission gear issues. As another example, a detected grinding sound of the transmission in a range of about 100-500 Hz, inclusive, can indicate synchronizer problems. As another example, a detected clunking sound of the suspension in a range of about 20-200 Hz, inclusive, can indicate worn suspension components. As another example, a detected squeaking sound of the suspension in a range of about 1-3 kHz, inclusive, can indicate lack of lubrication. As another example, a detected rattling sound of the exhaust in a range of about 100-200 Hz, inclusive, can indicate loose components. As another example, a detected hissing sound of the exhaust in a range of about 4-6 kHz, inclusive, can indicate an exhaust leak. As another example, a detected thumping sound of the tires in a range of about 20-100 Hz, inclusive, can indicate a tire flat spot. As another example, a detected whining sound of the tires in a range of about 200-300 Hz, inclusive, can indicate misalignment of the tire(s). As another example, a detected whistling sound of the HVAC system in a range of about 2-5 kHz, inclusive, can indicate a clogged air filter. As another example, a detected squealing sound of the HVAC system in a range of about 1-3 kHz, inclusive, can indicate a failing blower motor.

As another example, one failure threshold 426 can be the existence of smoke at areas of the vehicle 406 which should not have smoke. As another example, one failure threshold 426 can be the consistency or density of exhaust being expelled from the vehicle 406. As another example, one failure threshold 426 can be the expected measurement of a properly inflated tire (e.g., the radius or diameter of the tire) and any deviation can be indicative of over or under inflation. As the vehicle 406 passes the vehicle 402, or vice versa, the sensors 408 can scan the vehicle 406, detect sounds within a preset range, and/or capture images/video of the vehicle 406 to determine if the failure thresholds 426 are exceeded. Over time, machine learning and/or artificial intelligence can be used to train the system 400 to accurately detect operational failures of the vehicles 406.

If the failure thresholds 426 are met and, therefore, no failure is detected, the vehicle 402 does not take any further action. However, if one or more of the failure thresholds 426 are exceeded—indicative of failure of one or more components—the vehicle 402 identifies the vehicle 406 as having a detected failure. Based on the type of characteristic detected, the processing device 404 can identify the type of failure or component failing on the vehicle 406. The vehicle 402 can transmit to mission control 422 the determination of component failure, and mission control 422 can, in turn, transmit an alert to the vehicle 406 to warn the driver of the vehicle 406 of the detected component failure. In some embodiments, the vehicle 402 can transmit the alert directly to the secondary vehicle 406 (and, optionally to mission control 422). In some embodiments, the vehicle 406 can be another autonomous vehicle and the transmitted alert can be to both to the vehicle 406 and mission control 422. Such alerts can occur in real-time or substantially real-time. The system 400 can thereby detect component failure of other vehicles 406 (or optionally its own internal subsystems), and alert the vehicle 406 and/or mission control such that action can be taken to remediate the failure.

FIG. 6 is a flowchart of a method of vehicle failure detection by the exemplary system 400 discussed herein. At 500, characteristic failure thresholds are electronically stored in a database. At 502, a secondary vehicle is detected around a primary vehicle with one or more sensors associated with the primary vehicle. At 504, instructions stored in a memory are executed with a processing device in communication with the one or more sensors and the database to perform operations for vehicle failure detection. At 506, a characteristic associated with the secondary vehicle is detected with the one or more sensors. At 508, a determination is made if the detected characteristic associated with the secondary vehicle meets or exceeds the characteristic failure threshold corresponding with the characteristic. At 510, if the detected characteristic exceeds the characteristic failure threshold correspond with the characteristic, the secondary vehicle is identified as having a detected failure. An alert can be transmitted to the secondary vehicle to notify of the potential component failure, allowing the secondary vehicle to remediate the failure. As such, the system 400 allows for detection and alerting of detected failures, assisting other vehicles in operating at optimal levels.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for vehicle failure detection, comprising:
one or more sensors associated with a primary vehicle, the one or more sensors configured to detect a secondary vehicle around the primary vehicle;
a database configured to electronically store characteristic failure thresholds; and
a processing device in communication with the one or more sensors and the database, wherein the processing device is configured to execute instructions stored in a memory to perform operations comprising:
detecting a characteristic associated with the secondary vehicle with the one or more sensors;
determining if the detected characteristic associated with the secondary vehicle meets or exceeds the characteristic failure threshold corresponding with the characteristic; and
if the detected characteristic exceeds the characteristic failure threshold corresponding with the characteristic, identifying the secondary vehicle as having a detected failure.

2. The system of claim 1, wherein the primary vehicle is an autonomous vehicle.

3. The system of claim 1, wherein the one or more sensors include at least one of a heat detection sensor, a sound detection sensor, or a visual sensor.

4. The system of claim 3, wherein the heat detection sensor is an infrared sensor.

5. The system of claim 3, wherein the sound detection sensor is a microphone.

6. The system of claim 3, wherein the visual sensor is a camera.

7. The system of claim 3, wherein the detected characteristic associated with the secondary vehicle is an overheating of one or more components of the secondary vehicle, and the heat detection sensor detects such overheating.

8. The system of claim 7, wherein the one or more components include at least one of brakes, an engine, bearings, or an axle.

9. The system of claim 3, wherein the detected characteristic associated with the secondary vehicle is an increased sound of one or more components of the secondary vehicle, and the sound detection sensor detects such increased sound.

10. The system of claim 3, wherein the detected characteristic associated with the secondary vehicle is an increased frequency of sound of one or more components of the secondary vehicle, and the sound detection sensor detects such increased frequency of sound.

11. The system of claim 3, wherein the detected characteristic associated with the secondary vehicle is an existence of smoke or fire from the secondary vehicle, and the visual sensor detects such existence of smoke or fire.

12. The system of claim 3, wherein the detected characteristic associated with the secondary vehicle is a deflated tire of the secondary vehicle, and the visual sensor detects such deflated tire.

13. The system of claim 3, wherein the sound detection sensor is configured to detect a deviation of sound of the secondary vehicle relative to a noise baseline expected for the secondary vehicle.

14. The system of claim 1, wherein the operations comprise transmitting an alert to the secondary vehicle of the detected failure from the primary vehicle.

15. The system of claim 1, wherein the operations comprise transmitting an alert to a mission control of the detected failure from the primary vehicle.

16. A computer-implemented method for vehicle failure detection, comprising:
electronically storing characteristic failure thresholds in a database;
detecting a secondary vehicle around a primary vehicle with one or more sensors associated with the vehicle; and
executing instructions stored in a memory with a processing device in communication with the one or more sensors and the database to perform operations comprising:
detecting a characteristic associated with the secondary vehicle with the one or more sensors;
determining if the detected characteristic associated with the secondary vehicle meets or exceeds the characteristic failure threshold corresponding with the characteristic; and
if the detected characteristic exceeds the characteristic failure threshold corresponding with the characteristic, identifying the secondary vehicle as having a detected failure.

17. The computer-implemented method of claim 16, wherein the one or more sensors include at least one of a heat detection sensor, a sound detection sensor, or a visual sensor.

18. The computer-implemented method of claim 17, wherein the detected characteristic associated with the secondary vehicle is an overheating of one or more components of the secondary vehicle, and the heat detection sensor detects such overheating.

19. The computer-implemented method of claim 17, wherein the detected characteristic associated with the secondary vehicle is an increased sound of one or more components of the secondary vehicle, and the sound detection sensor detects such increased sound.

20. The computer-implemented method of claim 17, wherein the detected characteristic associated with the secondary vehicle is an increased frequency of sound of one or more components of the secondary vehicle, and the sound detection sensor detects such increased frequency of sound.
